(19) United States
(12) Patent Application Publication
(10) Pub. No.: US 2009/0105941 A1
(43) Pub. Date: Apr. 23, 2009

(54) AUTOMATIC DESTINATION DETERMINATION FOR MULTIPLE TRAVELERS DEPARTING FROM MULTIPLE SOURCE LOCATIONS BASED ON USER SPECIFIED CRITERIA

(75) Inventors: SIMON K. JOHNSTON, SILER CITY, NC (US); KEVIN E. KELLY, RALEIGH, NC (US); JAN J. KRATKY, RALEIGH, NC (US); STEVEN K. SPEICHER, APEX, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/873,819

(22) Filed: Oct. 17, 2007

(51) Int. Cl. G01C 21/26

(52) U.S. Cl. 701/202

(57) ABSTRACT

The present invention discloses a software implemented solution for automatically determining a travel destination. The method can identify a set of source locations, each source location representing a starting location of a traveler. Criteria for a destination to which each of the travelers is to travel can then be identified. At least one destination can be determined based upon the identified criteria. Directions for traveling from each of the source locations to the determined destination can be constructed.

### BACKGROUND

1. Field of the Invention

The present invention relates to the field of navigation or route determination software and, more particularly, to automatic destination determination for multiple travelers departing from multiple source locations based on user specified criteria.

2. Description of the Related Art

Today, more than ever, travel is a major part of professional and personal life. Mapping and navigation solutions that aid travelers are now more widely available. A driving technology behind mapping and navigation is the global positioning system (GPS). Through the use of GPS technology, travel websites, GPS devices, and mapping/navigation capable software, users are able to obtain travel directions to a myriad of destinations. A common problem with these solutions however, is that travelers are limited to specifying only one source location and must manually determine a destination.

In many situations, two or more travelers in different locations require an equidistant or another intermediate location in which to meet. In such a scenario, travelers are forced to manually determine a meeting place. Often times, users are unfamiliar with foreign locations and must randomly pick a meeting site or heavily research a geographic area to find a good location to meet. Both of these options do not fully leverage the accumulated wealth of navigation and mapping data available. It would be advantageous if there was a solution for handling multiple source locations, in addition to providing optimum destination options based on traveler specified conditions.

### SUMMARY OF THE INVENTION

The present invention discloses a solution for automatically determining destination points for multiple source locations based on user specified criteria. In the solution, a machine determined destination can be determined based on user specified data, such as multiple source locations, preferred points of interest, and routing/selection conditions and limitations. A data store of points of interest sites for geographic locations can be used in association with mapping data to create computed routes to a given point of interest destination. Multiple routing options can be presented to the user based on conditions and limitations specified. User provided information such as source locations, preferred points of interest, routing options, and the like can be stored in a user profile for future use.

The present invention can be implemented in accordance with numerous aspects consistent with the materials presented herein. One aspect of the present invention can include a software implemented method for automatically determining a travel destination. The method can identify a set of source locations, each source location representing a starting location of a traveler. Criteria for a destination to which each of the travelers is to travel can then be identified. At least one destination can be determined based upon the identified criteria. Directions for traveling from each of the source locations to the determined destination can be constructed.

Another aspect of the present invention can include a navigation system that includes a mapping data store, a point of interest data store, a point of interest selector, and a route determination engine. The mapping data store can include travel path data able to be used by a machine to determine a travel pathway from a starting point to a destination point. The point of interest data store can include a set of point of interest locations and facilities and activities available at each. The point of interest selector can be configured to determine at least one point of interest from data contained in the point of interest data store given input of a plurality of source locations and travel criteria. The point of interest can be selected by the point of interest selector to satisfy the travel criteria and to be a destination of best convenience for the plurality of travelers assuming the travelers depart from the source locations and travel to the determined point of interest. The route determination engine can determine and construct travel paths from each of the source locations to the determined point of interest based upon the data contained in the mapping data store. The point of interest selector and the route determination engine can be implemented within software stored within a machine readable medium, where said software comprises a set of programmatic instructions that causes an executing machine to perform actions for which the software is configured.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory or any other recording medium. The program can also be provided as a digitally encoded signal conveyed via a carrier wave. The described program can be a single program or can be implemented as multiple subprograms, each of which interact within a single computing device or interact in a distributed fashion across a network space.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for automatic destination determination for multiple source locations based on user specified criteria in accordance with the embodiment of inventive arrangements disclosed herein.

FIG. 2 is a schematic diagram illustrating a graphical user interface (GUI) for performing automatic destination determination for multiple source locations based on user specified criteria in accordance with the embodiment of inventive arrangements disclosed herein.

FIG. 3 is a flowchart diagram illustrating a method for automatic destination determination for multiple source locations based on user specified criteria in accordance with the embodiment of inventive arrangements disclosed herein.

### DETAILED DESCRIPTION OF THE INVENTION

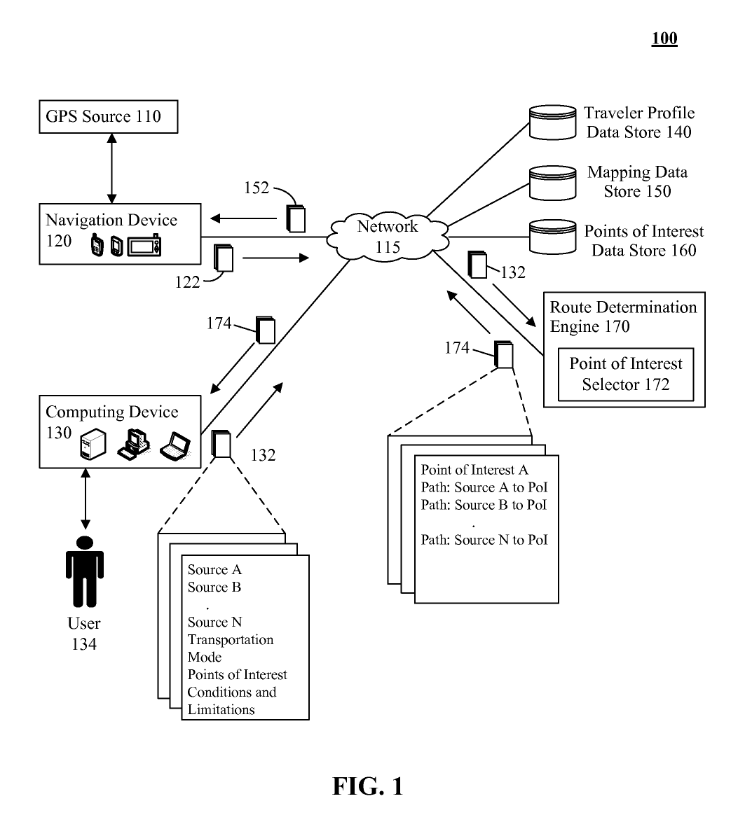

FIG. 1 is a schematic diagram illustrating a system 100 for automatic destination determination for multiple source locations based on user specified criteria in accordance with the embodiment of inventive arrangements disclosed herein. In system 100, a user 134, utilizing computing device 130, can obtain one or more automatically determined destinations given a set of user specified parameters, such as two or more source locations for different travelers, preferred point of interest types, traveler specific limitations, and the like. Route determination engine 170 can act in cooperation with point of interest selector 172 to compute one or more destinations (e.g., Point of Interest A, Point of Interest B, . . . Point of Interest N) based upon user provided criteria 132 and can create travel documents 174 from each source location (e.g., Source A, Source, B, . . . Source N) to each automatically determined point of interest. The destinations are automatically selected based upon the criteria 132, as opposed to being manually selected.

For example, a trip coordinator (user 134) can use computing device 130 to plan a trip involving two different families, who want to meet at a theme park. The user 134 can provide criteria 132 specifying the starting locations for each family (Source A and Source B), a mode(s) of transportation (e.g., driving, flying, etc.), points of interest criteria (e.g., theme parks), and conditions and limitations (e.g., find an approximately equidistant meeting point for the two families). The route determination engine 170 can process the criteria 132, and can generate one or more possible theme parks meeting the criteria 132. For each theme park, a travel document 174 can be sent to the computing device 130, which provides mapping information from each source (e.g., starting location) to the determined theme park. The user 134 can select one of the theme parks and mail travel instructions and a travel itinerary (based on document 174) to other travelers (the other family involved in the trip).

In one embodiment, functions can be built into a travel system that uses engine 170, so that each traveler is provided with a tailored travel document specific to their travel path. Further, collaboration functions can optionally be integrated into the travel system to permit interactions among multiple travelers, when selecting a preferred point of interest. System 100 can optionally include a data store 140 including traveler profile information, which can be used to supplement trip/event specific criteria 132. For example, a traveler can specify in their profile 140 that they are unable to take trips costing more than X and that are Y miles away from their starting location. Use of profiles can be advantageous as it minimizes a complexity required for criteria 132 for each travel event. Further, profiles can permit each travel to establish traveler restrictions, which minimizes needed coordination times.

Points of interest data store 160 can include locations of significance for a geographic area such as parks, recreational vehicle (RV) campgrounds, theme parks, and the like. In one embodiment, points of interest data store 160 can present preferred points of interest based on a ranking system. The ranking system can include, but not limited to, an open public ranking system, paid ranking, and the like.

Utilizing mapping data store 150 and point of interest 160 data store, route determination engine 170 can be used to calculate a route to a determined point of interest. A route from each source location to the determined point of interest can be computed. Determined destinations can be based upon multiple criteria and/or conditions, such as travel distance, travel time, monetary cost, and the like. Determined points of interest need not be equidistant from each source, although that may be a default setting for point of interest selector 172. Instead, one or more criteria can be established that indicate one traveler is able to travel further (or travel longer, pay more, etc. depending on trip specific settings) than another. For example, a single family member traveling to a family gathering may be able to conveniently travel further than a married family member with young children. Multiple conditions, criteria, and trade-offs can be considered by the point of interest selector 172. Once a point of interest is determined, the route determination engine 170 can produce travel documents 174 from each source to the point of interest.

The travel documents 174 can be results produced by a travel planning program, such as MAPQUEST, and/or can represent results consumable by a navigation device 120, in which case the travel documents 174 can be automatically formatted into a form 152 consumable by the device 120. In one embodiment, the route determination engine 170 and point of interest selector 172 can be capable of dynamically changing a primary point of interest to a secondary one, as circumstances change. For example, a meeting time can be a primary consideration for two parties driving to a meeting point in navigation device 120 equipped vehicles. Each vehicle can periodically provide navigation information 122 concerning a present location to the engine 170. In the example, the engine 170 can determine that one of the parties is “late” or that traffic conditions make timely attendance at a primary destination (point of interest) impossible. The engine 170 can further determine that a meeting time can be preserved if both parties travel to a secondary destination instead of the primary one. Notices to this effect and updated navigation information can be conveyed from the engine 170 to each of the navigation devices 120. Navigation devices 120 (e.g., Global Positioning System (GPS) equipped ones) can make determinations of present locations based upon signals from multiple GPS sources 110.

As used herein, the navigation device 120 can be a computing device capable of using positioning data to provide navigation functionality. The computing device 130 can be any device able to convey criteria 132 to engine 170 and to receive travel instructions 174 in response. For example, computing device 130 can be a computer, a mobile phone, a personal data assistant, a navigation device 120, and the like.

The route determination engine 170 can include a software program capable of calculating routes to one or more points of interest based on user specified criteria 132. Route determination engine 170 can determine a route for each of the candidates selected by points of interest selector 172. A set of possible travel pathways can be calculated by the route determination engine 170 from each source to each point of interest, and an optimal one can be determined from this set. Different traveler specific settings, such as those in traveler profile data store 140, can specify traveler specific criteria (such as fastest route, shortest distance, etc.) for determining the optimal travel path. The route determination engine 170 can be integrated into a network element accessible by computer device 130 and/or device 120. The route determination engine 170 can also be software executing locally within device 130 and/or 120.

The points of interest selector 172 can be software configured to determine preferred sites or destinations, which most closely match user specified criteria. Points of interest selector 172 can use a set of heuristic or deterministic routines when calculating the points of interest.

Data stores 140-160 can be physically implemented within any type of hardware including, but not limited to, a magnetic disk, an optical disk, a semiconductor memory, a digitally encoded plastic memory, a holographic memory, or any other recording medium. Each of the data stores 140-160 can be stand-alone storage units as well as a storage unit formed from a plurality of physical devices, which may be remotely located from one another. Additionally, information can be stored within each data store in a variety of manners. For example, information can be stored within a database structure or can be stored within one or more files of a file storage system, where each file may or may not be indexed for information searching purposes.

Network 115 can include any hardware/software/and firmware necessary to convey digital content encoded within carrier waves. Content can be contained within analog or digital signals and conveyed through data or voice channels and can be conveyed over a personal area network (PAN) or a wide area network (WAN). The network 115 can include local components and data pathways necessary for communications to be exchanged among computing device components and between integrated device components and peripheral devices. The network 115 can also include network equipment, such as routers, data lines, hubs, and intermediary servers which together form a packet-based network, such as the Internet or an intranet. The network 115 can further include circuit-based communication components and mobile communication components, such as telephony switches, modems, cellular communication towers, and the like. The network 115 can include line based and/or wireless communication pathways.

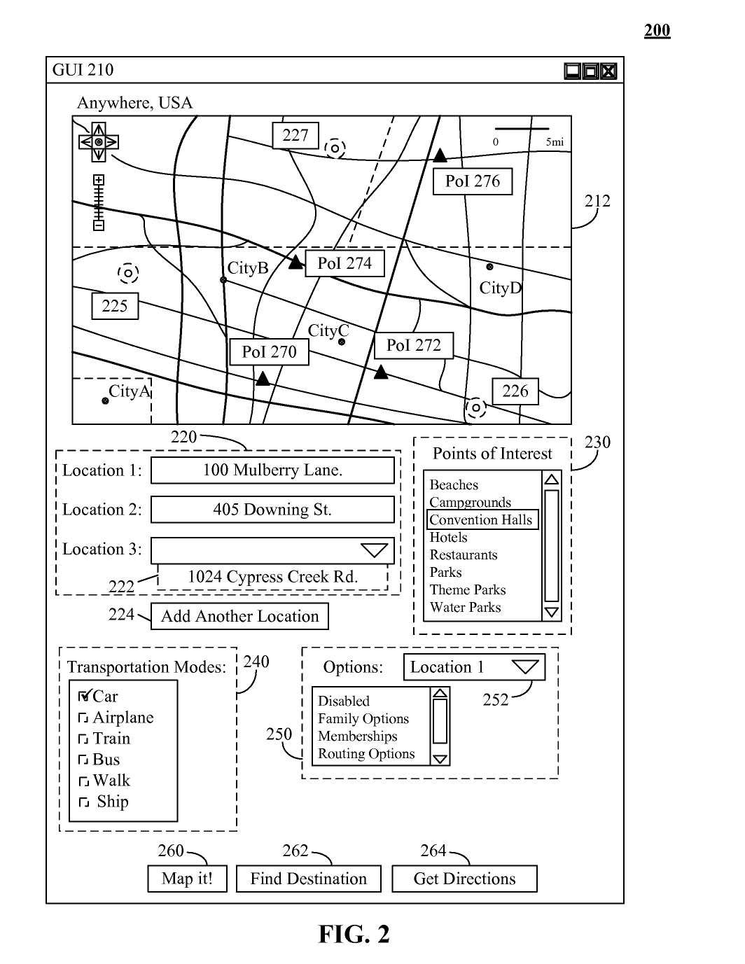

FIG. 2 is a schematic diagram illustrating a graphical user interface (GUI) 200 for performing automatic destination determination for multiple source locations based on user specified criteria in accordance with the embodiment of inventive arrangements disclosed herein. GUI 200 can be performed in the context of system 100. In GUI 200, a user can obtain one or more optimum destinations given two or more source locations 220 and points of interest 230.

Source locations 220 can be visually presented on map 212 to indicate relative distances and geographic locations as shown by 225-227. Source locations 220 can include street addresses, zip codes, city names, and the like. In one embodiment, a pull-down box 222 can present a user with past source locations. In another embodiment, past source locations 220 can be presented based on text pattern matching as the user types in the location. Past source locations 220 can be stored in a user history which can include a traveler profile data store 140. GUI 210 can provide a user-specified default number of source locations 220. Additional source locations can be added through interaction with button 224. In one embodiment, source locations 220 can be capable of contact list lookups allowing the user to specify the name of a contact's address to use.

Points of interest 230 can allow a user to select one or more destination types 270-276. Destination options 270-276 can be presented on map 212 responsive to selecting button 260. Points of interest 230 can include, but not limited to, beaches, convention halls, hotels, restaurants, and the like. Selection of points of interest 230 can be achieved through a multi-select box enabling a user to add or remove categories of points of interest. In one embodiment, frequently used points of interest can be bookmarked allowing rapid access. In another embodiment, points of interest 230 list can be sorted to present most recent points of interest at the top of the list.

Transportation modes 240 can facilitate more customized destination results based on user needs. Transportation modes 240 can include, but not limited to, automobiles, trains, airplanes, walking, and the like. Modes 240 can present a user with checkboxes which can allow a user to select multiple modes as necessary. Default modes, such as automobiles and walking can be user profile specified defaults as well as application level defaults.

Optional restrictions and requirements to each source location 220 can be provided using section 250. Each source location can have one or more associated options that can be used when calculating an optimum destination. Location options can include conditions shown in section 250. In one embodiment, routing options can include, but not limited to, avoidance of traffic heavy roads, toll roads, and the like.

Destination options 270-276 and routes (not shown) can be presented on map 212 when a user interacts with button 262. A user can obtain directions from source locations 220 to determined destination via button 264. In one embodiment, a determined destination can be communicated by GUI 210 to a GPS unit to enable a user to obtain directions in real time during transit.

GUI 210 is for illustrative purposes only and should not be construed to limit the invention in any regard. That is, the interface elements and functionally expressed in GUI 210 can be adapted for different situations and still be considered within scope of the present invention. Further, many contemplated options not presented in GUI 210 are to be considered as part of the invention. For example, the interface 210 can be enhanced to permit travel itineraries to be mailed to each traveler, which is customized based upon the traveler's source location. The interface 210 can also include a current position (not shown) of each traveler, which is dynamically updated as travelers approach an established point of interest. In another example, interface 210 can be a collaborative interface showing input and/or text discussions (e.g., within a text exchange window for example) from multiple travelers converging on the selected shared destination.

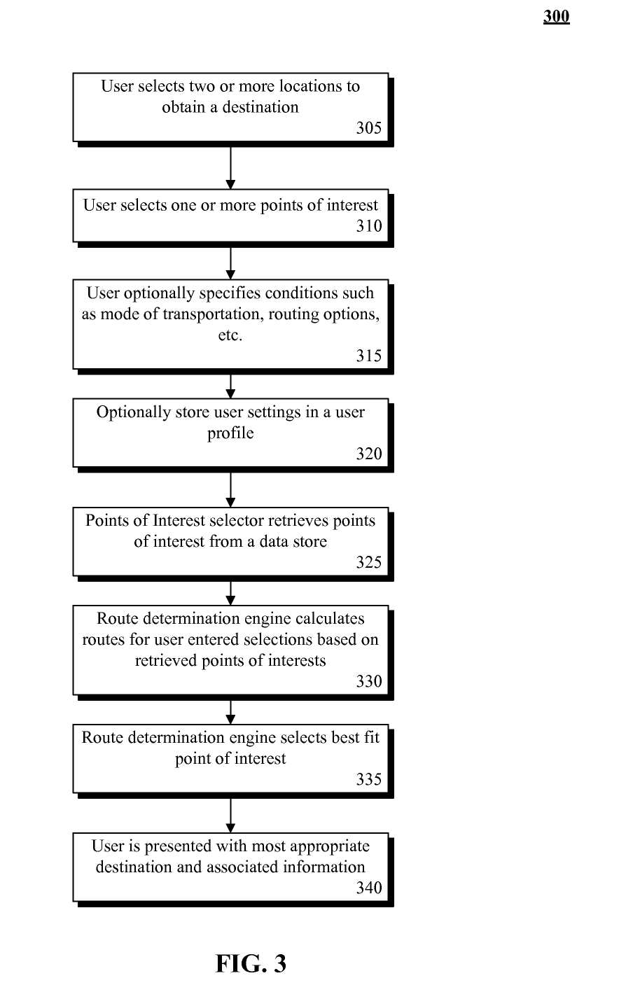

FIG. 3 is a flowchart diagram illustrating a method 300 for automatic destination determination for multiple source locations based on user specified criteria in accordance with the embodiment of inventive arrangements disclosed herein. Method 300 can be performed in the context of system 100. In method 300, a user can obtain an optimum destination for a set of locations and points of interest. The determined destination can include routing/navigation information for each of the locations.

In step 305, a user can select two or more locations to obtain a destination. Additional information such as one or more points of interest can be selected by the user, as shown in step 310. In step 315, the user may optionally specify conditions such as mode of transportation preferred, routing options, and the like to constrain the determined destination selection. Conditions/limitations can be optionally stored in a user profile for later use, as shown in step 320.

In step 325, a points of interest selector retrieves points of interest from a data store. In step 330, points of interest can be used by route determination engine to calculate routes for each point of interest. In step 335, each calculated route can be compared and a best fit route can be selected. In step 340, the user can be presented with the most appropriate destination and associated information such as navigation instructions, distance information, and the like.

The present invention may be realized in hardware, software or a combination of hardware and software. The present invention may be realized in a centralized fashion in one computer system or in a distributed fashion where different elements are spread across several interconnected computer systems. Any kind of computer system or other apparatus adapted for a carrying out methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

What is claimed is:

1. A method for automatically determining a travel destination comprising:
identifying a plurality of source locations, each source location representing a starting location of a traveler;
identifying criteria for a destination to which each of the travelers is to travel;
determining at least one destination based upon the identified criteria; and
creating directions for traveling from each of the source locations to the determined destination, wherein the steps of claim 1 are performed by a machine executing a set of programmatic instructions, which are stored on a machine readable medium.

2. The method of claim 1, wherein the source locations and the criteria are user entered values, and wherein the destination is a machine determined destination.

3. The method of claim 1, wherein the determined destination is selected to satisfy the criteria and to be a destination of best convenience for the plurality of travelers.

4. The method of claim 1, wherein the criteria establish a destination category specified based upon desired facilities and activities available for the travelers at the destination.

5. The method of claim 1, wherein the criteria specifies that each traveler is to drive to the destination, wherein the directions for traveling comprise driving instructions.

6. The method of claim 5, wherein the driving instructions are automatically formatted for at least one navigation system used by one of the travelers to travel to the determined destination, wherein the navigation system is able to use the formatted instructions to direct the traveler to the destination.

7. The method of claim 5, wherein each of the plurality of travelers uses a vehicle navigation system to provide driving directions, wherein the created driving directions are automatically conveyed to the navigation systems, and wherein the navigation systems continuously track a present location of other ones of the travelers during a trip to the determined location.

8. The method of claim 1, wherein the criteria establishes that each of the travelers is to be approximately equally inconvenienced when traveling from a traveler specific source location to the determined destination.

9. The method of claim 8, wherein the inconvenience is computed based upon at least one of the following conditions: travel cost, travel time, and travel distance.

10. The method of claim 1, wherein the machine is a network server, said method further comprising:
a user of a client connecting to the network server over a network, wherein the user inputs the source locations, and the criteria;
the network server computing the at least one destination and creating the directions, which are specified within an electronic document conveyed over the network to the client; and
the client presenting content of the electronic document to the user.

11. A navigation system comprising:
a mapping data store comprising travel path data able to be used by a machine to determine a travel pathway from a starting point to a destination point;
a point of interest data store comprising a plurality of point of interest locations and facilities and activities available at each;
a point of interest selector configured to determine at least one point of interest from data contained in the point of interest data store given input of a plurality of source locations and travel criteria, wherein the point of interest is selected by the point of interest selector to satisfy the travel criteria and to be a destination of best convenience for the plurality of travelers assuming the travelers depart from the source locations and travel to the determined point of interest;
a route determination engine configured to determine and construct travel paths from each of the source locations to the determined point of interest based upon the data contained in the mapping data store, wherein the point of interest selector and the route determination engine are implemented within software stored within a machine readable medium, where said software comprises a set of programmatic instructions that causes an executing machine to perform actions for which said software is configured.

12. The system of claim 11, wherein the travel paths are driving paths, said system further comprising:
at least one navigation device comprising a location detector, wherein said navigation device is contained within a motor vehicle that travels from one of the source locations to the determined point of interest, wherein said route determination engine formats the constructed travel path associated with the one source location in a form consumable by the at least one navigation device, and wherein said at least one navigation devices guides a traveler to the point of interest.

13. The system of claim 11, wherein the criteria specify a level of inconvenience that each of the travelers is to experience when traveling from a source location to the point of interest, wherein the level of inconvenience is based upon at least one of the following factors: travel cost, travel time, and travel distance.

14. The system of claim 13, wherein the level of inconvenience for each traveler multiplied by a traveler specific constant factor is to be as equivalent as possible given constraints imposed within the criteria and given a set of points of interest contained in the data store.

15. The system of claim 14, wherein the traveler specific constant factor is a configurable value used to weight relatively inconveniences to make travel to the point of interest relatively less convenient to one of the travelers compared to another of the travelers.
